(19) United States
(12) Patent Application Publication
(10) Pub. No.: US 2022/0391569 A1
(43) Pub. Date: Dec. 8, 2022

(54) PARALLEL AND SCALABLE COMPUTATION OF STRONGLY CONNECTED COMPONENTS IN A CIRCUIT DESIGN

(71) Applicant: Synopsys, Inc., Mountain View, CA (US)

(72) Inventors: Olivier Rene Coudert, Sunnyvale, CA (US); Florent Sébastien Marc Emmanuel Claude Duru, Shrewsbury, MA (US); Francois Peneloux, Northborough, MA (US); Pierre Delpeuch, Palo Alto, CA (US)

(21) Appl. No.: 17/748,987

(22) Filed: May 19, 2022

Related U.S. Application Data
(60) Provisional application No. 63/196,076, filed on Jun. 2, 2021.

(51) Int. Cl. G06F 30/331; G06F 9/48

(52) U.S. Cl. CPC G06F 30/331; G06F 9/4843; G06F 2111/02

(57) ABSTRACT

A system identifies strongly connected components of a circuit design. The system receiving a circuit design represented as a graph including a set of vertices and a set of edges. The system marks each vertex of the set of vertices void. The system executes multiple threads, where each thread performs following steps concurrently. The thread selects a vertex from the set of vertices with void state. The thread performs a depth first search starting from the selected vertex. The thread marks a vertex as processed once the depth first search started from that vertex is completed. The depth first search skips vertices marked as processed. The thread determines a candidate SCC based on the nodes traversed by the depth first search. Once a set of candidate SCCs is determined, the system eliminates some of the candidate SCCs and stores the remaining candidate SCCs as SCCs of the graph.

### CROSS REFERENCE TO RELATED APPLICATIONS

This application claims a benefit of U.S. Patent Application Ser. No. 63/196,076, filed Jun. 2, 2021, the contents of which are incorporated by reference herein in its entirety.

### TECHNICAL FIELD

The present disclosure relates to design of electronic circuits in general, and more specifically to identifying strongly connected components in a circuit design represented as a graph.

### BACKGROUND

Electronic design automation of circuit designs includes various types of analysis. Circuit designs are represented as a netlist for certain types of analysis, for example, for static timing analysis. A netlist representation of a circuit design may include loops that can cause multiple issues, both for correctness and complexity. For example, loops in netlists can complicate processing such as logic optimization, static timing analysis, simulation, or formal verification. Therefore, it is important to identify loops in netlists representations of circuit designs so that these portions can be analyzed differently. Often circuit designs being analyzed are very large, for example, very large scale integrated (VLSI) circuits including billions of gates and are difficult to process using a single processor. Several known techniques for identifying loops in circuit designs are suitable for executing on a single processor only.

### SUMMARY

A system identifies strongly connected components (SCCs) of a circuit design. The system receiving a circuit design represented as a graph including a set of vertices and a set of edges. The system initializes the graph by marking each vertex as void. The system executes multiple threads, each thread performing following steps concurrently. Each thread selects a vertex with void state and performs a depth first search starting from the selected vertex. The thread marks a vertex as processed once the depth first search started from that vertex is completed. If the thread encounters a vertex marked as processed during the depth first search, the thread skips the vertex. Each thread determines a candidate SCC based on the depth first search. Once a set of candidate SCCs is determined, the system eliminates some of the candidate SCCs as incomplete SCCs and stores the remaining candidate SCCs as the SCCs computed for the circuit design.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates the process for identifying SCCs in a circuit design according to an embodiment.

FIG. 2 is a block diagram illustrating the system architecture of a circuit design analysis system for identifying SCCS of a circuit design according to an embodiment.

FIG. 3 depicts a flowchart of the overall process for identifying SCCs using multiple threads executing in parallel according to an embodiment.

FIG. 4 depicts a flowchart of the process for identifying SCCs executed by each thread according to an embodiment.

FIG. 5 depicts a flowchart of the process for eliminating incomplete SCCs according to an embodiment.

FIGS. 6A-F show examples of processing performed using overlapping threads according to an embodiment.

FIG. 7 depicts a flowchart of various processes used during the design and manufacture of an integrated circuit in accordance with some embodiments of the present disclosure.

FIG. 8 depicts a diagram of an example computer system in which embodiments of the present disclosure may operate.

### DETAILED DESCRIPTION

A system according to an embodiment, represents a circuit design as a directed graph and identifies loops in the circuit design by identifying strongly connected components (SCCs). The system may further analyze and process the loops. The system determines SCCs of a graph using a parallel technique that can run on multiple processors. The system starts multiple threads that can run in parallel. Each thread performs a depth first search of the graph to identify a candidate SCC. The depth first search includes traversing the graph by beginning at a selected vertex and proceeding as far as possible along each branch of the graph. Since all threads start execution in parallel, some of the threads determine candidate SCCs that are subsets of other SCCs. The system identifies these SCCs as incomplete SCCs and eliminates them. The system returns the remaining SCCs.

Typical techniques for identifying SCCs process the input circuit design sequentially by identifying the strongly connected components one at a time. This makes processing of large circuit designs that may include billions of gates very costly. Certain approaches to parallel SCC require instant access to both direction of the edges of a vertex to perform forward and backward traversal. This requires extra memory. One approach for computing SCCs called Trajan's algorithm does not require instant access to both direction of the edges of vertices, but is inherently sequential. In contrast, the disclosed techniques can be executed in parallel on multiple processes.

The techniques disclosed herein may be used for various EDA processes that determine SCCs, for example, circuit partitioning, logic optimization, static timing analysis, simulation, formal verification, or model checking. The techniques disclosed may be used by a compiler for emulation, so that the system can process the SCCs and break the loops in a safe way without changing the circuit behavior). The techniques disclosed herein may also be used for other applications that are not related to circuit designs, for example, in social networking systems. In social networking systems, a group of people connected as friends or sharing common tastes are generally strongly connected. The processes disclosed herein for determining SCCs can be used to identify such groups and make recommendations for friends in the social networking system or resources they may enjoy for example, content such as videos, streaming content, products/services in an online store, and so on.

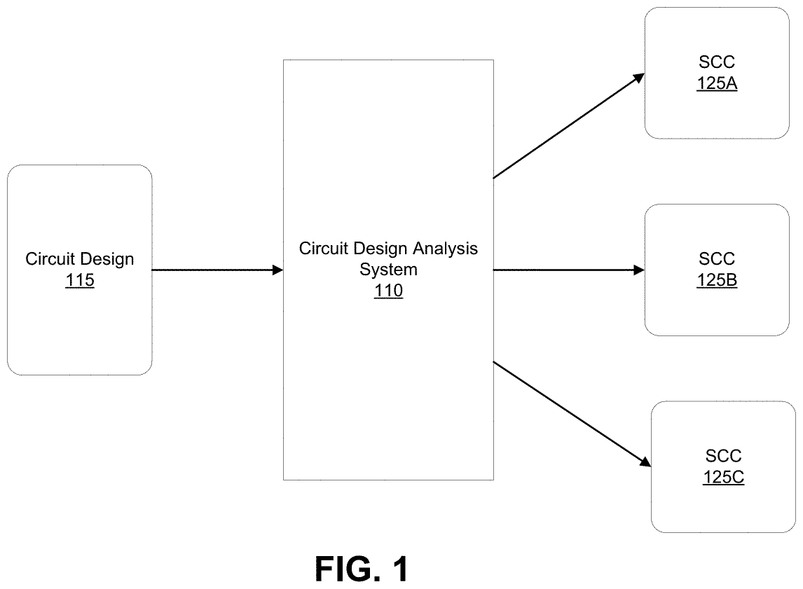

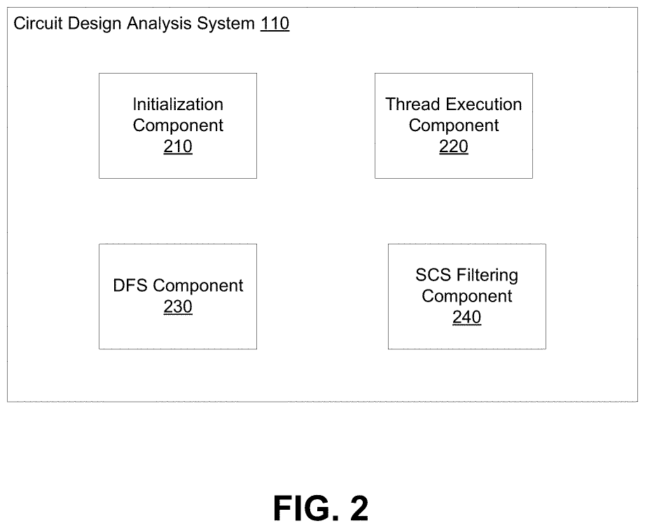

FIG. 1 illustrates the process for identifying SCCs in a circuit design according to an embodiment. The circuit design analysis system 110 receives an input circuit design 115 and identifies SCCs 125A, 125B, 125C in the input circuit design. The architecture of the circuit design analysis system 110 is shown in detail in FIG. 2 and described in connection with FIG. 2. The circuit design analysis system 110 is also referred to herein as a system.

Embodiments of the system execute processes for parallel computation of SCCs. The system generates multiple threads to explore the input graph at once and is therefore able to exploit higher degree of parallelism compared to typical systems. Since multiple threads start processing the graph in parallel, it is possible for multiple threads to process the same SCC. For example, if one thread starts processing the SCC from one vertex and the other thread starts processing the same SCC from another vertex, both threads are processing the same SCC.

Once a thread determines vertices of an SCC, the thread marks the vertices of the SCC as PROCESSED. If a thread encounters a vertex V1 marked as PROCESSED while performing the depth first search, the thread skips the vertex V1 and may determine a smaller SCC S1 that is a proper subset of a bigger SCC S2 that includes vertex V1. This allows multiple threads to process SCCs in parallel. The SCC S1 is determined to be an incomplete SCC. The system identifies and filters out the incomplete SCCs from the set of SCCs determined and returns the filtered set of SCCs. Accordingly, the system is able to determine strongly connected components faster than other techniques by using multiple processors. For example, the techniques disclosed were experimentally measured to reduce SCC computation that takes one hour or more on large netlists to a couple of minutes using a 20 cores machine.

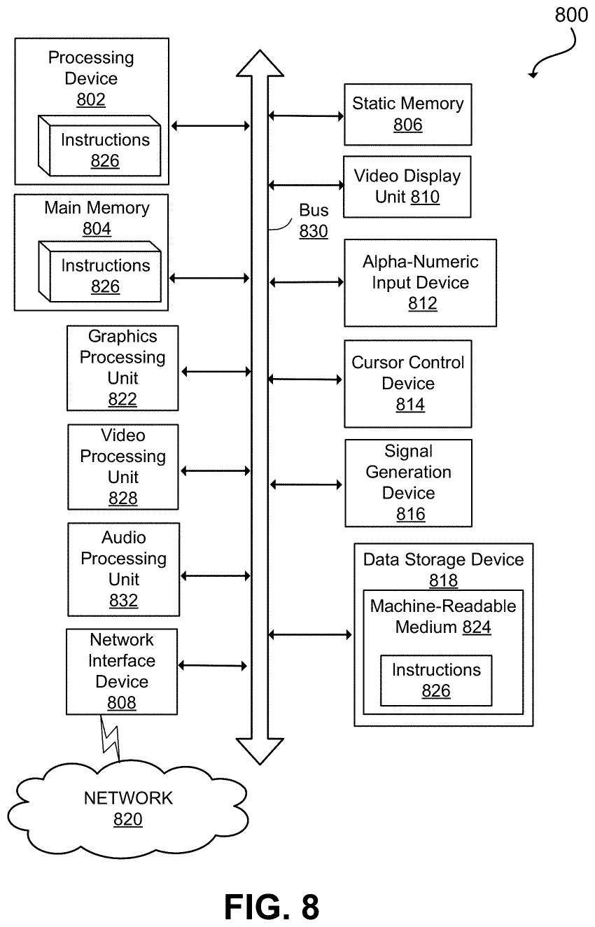

FIG. 2 is a block diagram illustrating the system architecture of a circuit design analysis system for identifying SCCs of a circuit design according to an embodiment. The circuit design analysis system 110 includes an initialization component 210, a thread execution component 220, a depth-first search (DFS) component 230, and a filtering component 240. Other embodiments may include more or fewer components than indicated herein. Furthermore, components may be combined such that steps described as being performed by a particular component herein may be performed by another component without deviating from the scope of the present disclosure. The components of the circuit design analysis system 110 are implemented by one or more processing devices (also referred to as computer processors), for example, the processing device shown in FIG. 8.

The initialization component 210 initializes the data structures. For example, the initialization component 210 initializes each vertex of the graph representation of a circuit design to a void value. The initialization component 210 may also initialize a queue data structure for storing the initialized vertices for processing.

The thread execution component 220 creates multiple threads for performing the computation of SCCs in parallel. The threads created by the thread execution component 220 runs concurrently. Each thread executes steps to determine a candidate SCC.

The DFS component 230 performs the steps for determining candidate SCCs from a given graph. The instructions of the DFS component 230 are executed by each thread in parallel. The instructions of the DFS component 230 are executed to determine a set of strongly connected subgraphs (SCSs) that represent candidate SCC components. According to an embodiment, the DFS component 230 performs DFS by starting at the root node (selecting some arbitrary node as the root node in the case of a graph) and exploring as far as possible along each branch before backtracking. According to an embodiment, the DFS component 230 uses a stack data structure to store nodes and the DFS process is completed when the stack is empty. For a recursive implementation of the DFS process, the call stack stores the paths traversed during the DFS.

The filtering component 240 eliminates incomplete SCCs from the set of candidate SCCs so that only valid SCCs remain. The filtering component 240 determines whether an SCS is a subset (e.g., a strict subset) of another SCC. If the filtering component 240 identifies an SCS that is a subset of another SCC, the filtering component marks that SCS as an incomplete SCC and eliminates it from the final set of SCCs that is returned by the system.

A netlist represents a circuit. A netlist is made of cells and nets. A cell has input and output ports. A net is a set of ports. A net connects its output ports (usually a net has only one output port) to its input ports. A cell c1 is in the fanin of cell c2 (respectively c2 is in the fanout of c1) if and only if (iff) there is a net that connects an output port of c1 to an input port of c2.

A netlist may be represented as a directed graph (V, E), where Vis the set of cells, and E is made of edges (v1, v2) where v1 is an output port, v2 an input port, and {v1, v2} belongs to a net. Practically computing SCCs in a netlist is performed by finding the non-trivial SCCs (i.e., the SCCs with size greater than 1) in the directed graph induced by the netlist.

The system generates directed graph representation of the input, for example, a netlist representation of a circuit design and processes it using the techniques disclosed herein. A directed graph G is represented as a couple of sets (V, E) of vertices V and edges E. The set of edges E is a subset of the cross product of vertices represented as V×V. A subgraph of G is a graph G′=(V′, E′), such that V′ is included in V, and E′ is included in (V′×V′) and E. A vertex v2 is a successor of vertex v1 iff (v1, v2) is an edge. Alternatively, v2 is in the fanout of v1, and v1 is in the fanin of v2. A vertex v2 is reachable from vertex v1 iff (if and only if) there is a sequence of edges (vᵢ, v_{{i+1}}), 0<=i<=n, such that v₀=v1 and v_{{n+1}}=v2. That sequence of edges is called a path from v1 to v2.

The transitive fanin (respectively transitive fanout) of a vertex v, referred to as TFI(v) (respectively TFO(v)), is the transitive closure of the fanin relation (respectively fanout) starting from a vertex v. Accordingly, TFI(v) (respectively TFO(v)) is the set of all vertices that can be reached from vertex v using only the fanin relation (respectively fanout relation).

A loop is a path from a vertex to itself. A self-loop is a loop that has a single edge (v, v). A graph is acyclic iff it does not contain any loop.

Two vertices v1 and v2 may be considered as being strongly connected if there is a path from v1 to v2 and a path from v2 to v1. A graph (or subgraph) may be considered as being strongly connected if there is a path between any two of its vertices. A strongly connected subgraph is referred to as an SCS. Being strongly connected is an equivalence relation (i.e., symmetric, reflexive, and transitive), and the induced subgraphs of its equivalence classes are called strongly connected components (SCCs). Equivalently, a SCC of a directed graph G is a SCS that is maximal such that no additional edge or vertex from G can be included in the SCS without violating its property of being strongly connected. Accordingly, every loop must be fully included in a SCC, and that any path in a SCC can be extended to a loop inside that SCC.

There are techniques for identifying SCCs with linear time complexity, i.e., they can be executed in a time asymptotically equal to C*(|V|+|E|), where C is a constant, |V| is the number of vertices, and |E| is the number of edges.

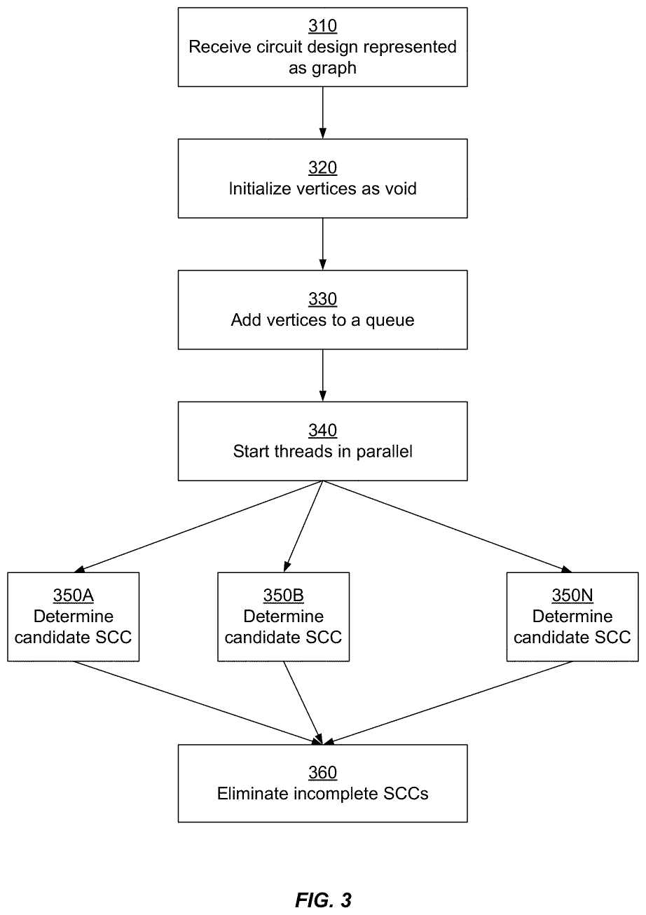

FIGS. 3-5 depict various flowcharts illustrating processes for identifying SCCs according to various embodiments. The steps are described as being executed by a system, for example, components of the circuit design analysis system 110. The steps may be executed in an order different from that depicted in the respective flowcharts.

FIG. 3 depicts a flowchart of the overall process for identifying SCCs using multiple threads executing in parallel according to an embodiment. The system receives 310 a circuit design represented as a graph. The process is executed on multiple cores (i.e., processing devices).

The system initializes 320 each vertex of the graph as void. The system marks a vertex v as PROCESSED if the system has explored TFI(v), and all the SCCs in TFI(v) have been determined (by one or multiple threads). This implies the SCC that vertex v belongs to has been identified, including the case of a trivial SCC only made of v. Accordingly, the state of a vertex is either VOID or PROCESSED.

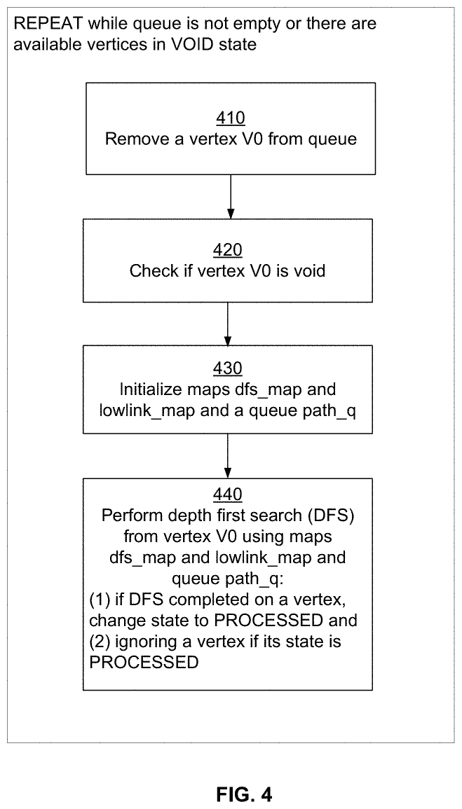

The system adds 330 the vertices to a queue structure. The system starts 340 multiple threads for parallel execution of the steps for determining 350A, 350B, . . . , 350N SCC components as shown in FIG. 4. Each thread performs the steps for determining 350 candidate SCCs. The process executed by each thread for identifying a candidate SCC is referred to as SCC discovery. The SCC discovery procedure computes non-trivial strongly connected subgraphs (SCS), i.e., SCSs with more than a single node. The parallel execution of the threads determines a set of candidate SCCs. The system eliminates 360 some of the candidate SCCs identified as incomplete SCCs. If an SCS is a subset (e.g., a strict subset) of a SCC, that SCS is identified as an incomplete SCC. The process guarantees that all SCCs are discovered. The threads generate SCSs which represent all candidates SCCs. Some of the candidate SCCs are actual SCCs and some SCCS may be incomplete SCCs.

Besides the vertex and fanin information (both read only), vertex state (writable) is the only shared data among threads. The system reads and writes vertex states atomically, i.e., whenever multiple threads attempt to write a status on the same vertex, only one succeeds, and as soon as the status is written, it is immediately available to be read by other threads.

FIG. 4 depicts a flowchart of the process for identifying SCCs executed by each thread according to an embodiment. Each thread executes the steps 410, 420, 430, and 440 while the queue is not empty. The thread removes 410 a vertex v0 from the queue and checks 420 if the vertex has state VOID. If a thread cannot find any vertex in VOID state, the system determines that all vertices are in state PROCESSED, and the thread terminates. Otherwise, the thread proceeds with executing a DFS on v0. The system according to various embodiments, executes a parallel implementation of Tarjan's SCC computation process. Accordingly, each thread applies a modified Tarjan's DFS for SCC computation.

The system tracks v.dfsNum, the DFS index (also represented as the time of discovery) of vertex v during a DFS. The DFS index is assigned to vertex v only once and does not change in value. Therefore, the system uses the DFS index to uniquely denotes the vertex v. The system performs a DFS from some unindexed vertex and iterates that process until all vertices have received a DFS index. As the system performs the DFS and indexing, the system maintains v.lowlink as the smallest DFS number (including v.dfsNum) observed when performing the DFS from v. The DFS performed from vertex v is included in TFI(v), but may not encounter the full TFI(v) as DFS indexes are assigned only once. Any vertex that has v.dfsNum is equal to v.lowlink defines a SCC. The system performs this computation using multiple threads.

Each thread initializes 430 structures that act as thread-local containers including a map dfs_map, a map lowlink_map, and a queue path_q. The map dfs_map is a data structure that stores the DFS number values for the nodes of the graph and the map lowlink_map stores the lowlink values of the nodes of the graph. The queue path_q is a queue data structure for storing paths to nodes during the DFS traversal. The thread uses the structures dfs_map, lowlink_map, and path_q, to annotate vertices without interfering with the other threads. The system stores (1) the values v.dfsNum as described herein in the map dfs_map (2) the values of v.lowlink as described herein in the map lowlink_map, and (3) the path of vertices traversed during the traversal in the queue path_q. The thread performs 440 DFS from vertex v0 using the maps dfs_map and lowlink_map and the queue path_q. If during the DFS, the thread encounters a vertex v that is already in state PROCESSED previously, the thread skips that v altogether. This is so because there is a guarantee of no path from v's transitive fanin (TFI) to v0, otherwise this implies that v0 is in the TFI of v, and therefore that v0 is in PROCESSED state, which is a contradiction.

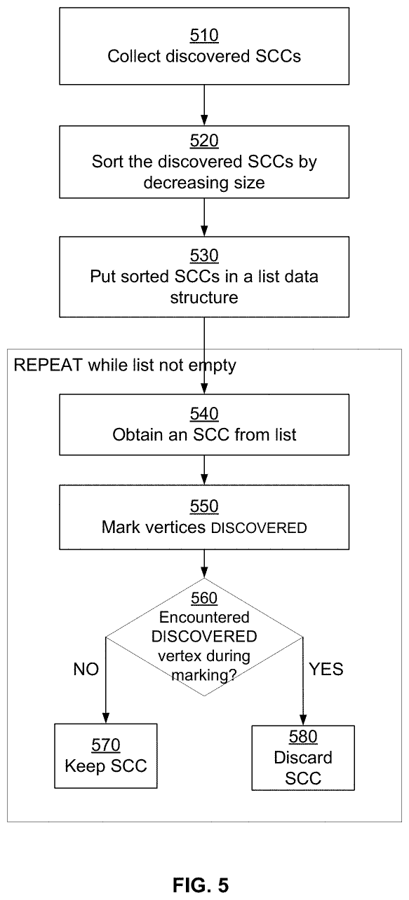

Assume that the current thread is referred to as thread t1. Whenever thread t1 encounters a PROCESSED vertex, t1 skips v's TFI visitation. The thread t1 skips a PROCESSED vertex whether the vertex was marked as PROCESSED by thread t1 or another thread t2. That still guarantees that all SCCs in v's TFI has been determined, either by thread t1, or by the another thread t2. If thread t1 skips a vertex marked PROCESSED by another thread t2, the process may generate a SCC that is a strict subset of the SCC found by t2. Once all candidate SCCs are identified, the system executes the process illustrated in FIG. 5 for eliminating incomplete SCCs, i.e., SCCs that are strictly included in another SCC.

FIG. 5 depicts a flowchart of the process for eliminating incomplete SCCs according to an embodiment. The system collects 510 the candidate SCCs discovered by the processes of FIGS. 3-4. The system sorts 520 the candidate SCCs in order of their decreasing size. The system puts 530 the sorted SCCs in a list data structure that allows addition and removal of elements.

The system repeats the steps 540, 550, 560, 570, and 580 while the list is not empty. The system visits the candidate SCCs in the sorted order. Accordingly, the system obtains 540, an SCC from the list. The system traverses the SCC to mark 550 the vertices of the SCC obtained from the list as DISCOVERED. The system determines 560 if a vertex encountered is already marked DISCOVERED while traversing the SCC. If the system determines 560 that a vertex encountered is already marked DISCOVERED, the system determines that the SCC is incomplete and discards 580 the SCC. This is so because the system determines that the SCC is a strict subset of a complete SCC that contains it and has been previously seen. If the system does not encounter any vertex that is already marked DISCOVERED while traversing the SCC, the system determines that the SCC is complete and keeps 570 the SCC.

The incomplete SCCs result from thread overlap, and therefore are non-deterministic. They do not impact the correctness of the final result since they are filtered out.

Because a vertex v can be marked as PROCESSED only by one thread, and subsequent discovery of that vertex by other threads will skip visiting v's TFI, the system obtains a net gain in terms of the wall time required to visit all the vertices. Furthermore, the techniques disclosed have properties that include using only use the fanin information, i.e., only need constant-time access to one direction of the edges.

Substituting “fanout” for “fanin” and “TFO” for “TFI” in the description above produces an equivalent process using only the fanout information. The system performs parallel execution using threads without using any mutex nor any complex thread synchronization. The system checks whether a vertex is already PROCESSED with an atomic read and updates the state of the vertex with an atomic write. This helps scalability as the number of threads is increased. This also allows threads to overlap, i.e., allowing multiple threads to visit the same vertex if the vertex has the VOID status, which possibly generate incomplete SCCs. As a result, the process avoids forced global synchronization, which is not a scalable solution.

Overall, the system computes SCCs on a directed graph in a parallel manner, which only need constant-time access to one direction of the edges. The system computes SCCs of a netlist in parallel using constant-time access to the fanin. The system may also compute SCCs in parallel using constant-time access to the fanout. The threads may overlap visitations of vertices, thus allowing the configuration to scale with the number of cores. The overlap in visitations of vertices by the threads results in generation of incomplete SCCs which are filtered out by the system.

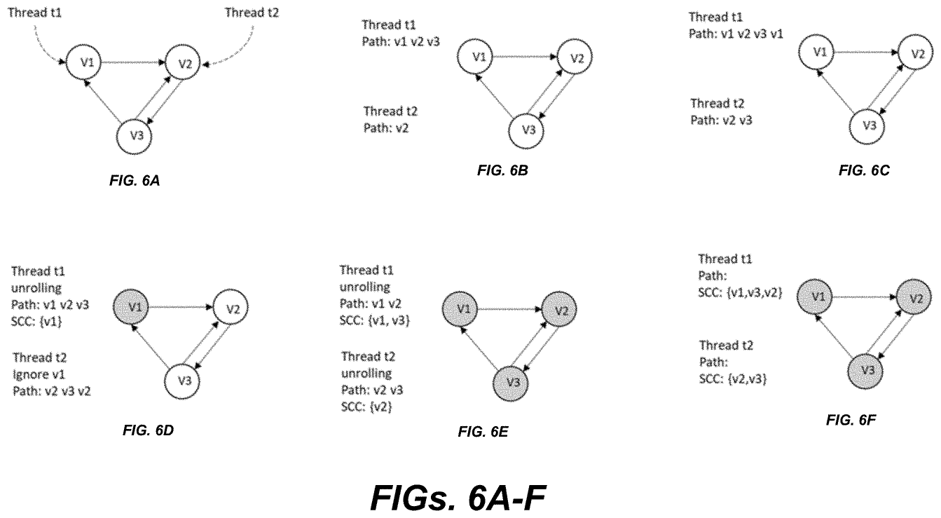

FIGS. 6A-F show examples of processing performed using overlapping threads according to an embodiment.

FIG. 6A shows a simple graph made of 3 vertices v1, v2, v3, and two threads t1 and t2. The state of vertices is shown with white (representing VOID state of vertex) and gray or shaded (representing PROCESSED state of vertex). Thread t1 starts its SCC discovery from v1, and thread t2 starts its SCC discovery from v2. The system uses the fanout direction for this example, i.e., the system follows the direction of the arrows during the DFS.

In FIG. 6B. both threads have started to perform a DFS from their respective starting vertex. Threads t1 has path v1, v2, v3; thread t2 has path v2. In FIG. 6C thread t1 reaches v1, which is already in its path. In the meantime, thread t2 continues its DFS and has path v2, v3.

In FIG. 6D threads t1 starts to update the lowlinks of the vertices as it unrolls its path for vertex whose TFO has been explored, and it incrementally grows the SCC rooted at v1. During that process, t1 marks the vertices that are unrolled from the path as PROCESSED, since their TFO has been visited. In that figure, t1 started building a SCC with {v1}, it marked v1 as PROCESSED, and is still unrolling its path. In the meantime, thread t2 continues its DFS, but sees v1 as PROCESSED, thus it ignores it. It eventually reaches v2, which it has already seen in its path.

In FIG. 6E thread t1 keeps unrolling its path, updating the lowlinks, and growing the SCC with the vertices that match the lowlink value (in that case the DFS number of v1, i.e., 1). The SCC grows to {v1, v3}, and v3 is marked PROCESSED. Thread t2 starts to unroll its path and grows a SCC {v2}. Note that t2 marks v2 as PROCESSED, because from its point of view it is processed. This will not impair t1 to find the full SCC as it includes unrolling the path and check t1's local lowlink value, not the vertex' state.

In FIG. 6F thread t1 finished unrolling its path to generate SCC {v1, v3, v2}. Thread t2 finished to unroll its path to generate {v2, v3}. The post processing will discard the latter SCS determined by thread t2 since it is included in the former i.e., SCS {v2, v3} is a subset of SCC {v1, v3, v2}. This example illustrates a computation using the process disclosed and is not intended to be limiting in any way. The techniques disclosed are applicable to any graph.

The techniques disclosed may be applied for various steps during electronic design of circuits, for example, static timing analysis, logic optimization, circuit partitioning etc.

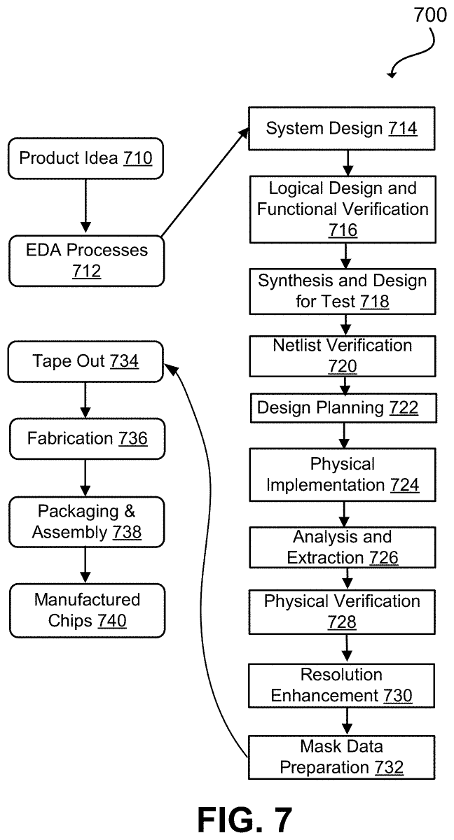

FIG. 7 illustrates an example set of processes 700 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 710 with information supplied by a designer, information which is transformed to create an article of manufacture that uses a set of EDA processes 712. When the design is finalized, the design is taped-out 734, which is when artwork (e.g., geometric patterns) for the integrated circuit is sent to a fabrication facility to manufacture the mask set, which is then used to manufacture the integrated circuit. After tape-out, a semiconductor die is fabricated 736 and packaging and assembly processes 738 are performed to produce the finished integrated circuit 740.

Specifications for a circuit or electronic structure may range from low-level transistor material layouts to high-level description languages. A high-level representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more concrete description adds more useful detail into the design description, for example, more details for the modules that include the description. The lower levels of representation that are more concrete descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding tools of that layer (e.g., a formal verification tool). A design process may use a sequence depicted in FIG. 7. The processes described by be enabled by EDA products (or tools).

During system design 714, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 716, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 718, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 720, the netlist is checked for compliance with timing constraints and for correspondence with the HDL code. During design planning 722, an overall floor plan for the integrated circuit is constructed and analyzed for timing and top-level routing.

During layout or physical implementation 724, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 726, the circuit function is verified at the layout level, which permits refinement of the layout design. During physical verification 728, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished integrated circuits.

A storage subsystem of a computer system (such as computer system 800 of FIG. 8) may be used to store the programs and data structures that are used by some or all of the EDA products described herein, and products used for development of cells for the library and for physical and logical design that use the library.

FIG. 8 illustrates an example machine of a computer system 800 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 830.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 826 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In some implementations, the instructions 826 include instructions to implement functionality corresponding to the present disclosure. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 802 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method for determining strongly connected components (SCCs) of a circuit design in parallel, the method comprising:
receiving a circuit design represented as a graph comprising a set of vertices and a set of edges;
for each vertex of the set of vertices, assigning, by a processor, a state of the vertex as void;
performing by each thread from a plurality of threads executing concurrently comprising
determining a set of candidate SCCs,
selecting a vertex from the set of vertices with the state as void,
performing a depth first search starting from the selected vertex,
marking a vertex as processed once the depth first search started from that vertex is completed, wherein the depth first search skips vertices previously marked as processed, and
determining a candidate SCC based on vertices traversed by the depth first search; and
eliminating one or more candidate SCCs from the set of candidate SCCs and storing remaining candidate SCCs as SCCs of the graph.

2. The method of claim 1, wherein eliminating one or more candidate SCCs comprises:
marking a strongly connected subgraph that is a subset of another strongly connected subgraph as an incomplete SCC; and
removing the incomplete SCC from the one or more candidate SCCs.

3. The method of claim 2, wherein marking a strongly connected component as incomplete comprises:
sorting the candidate SCCs in order of decreasing size as a sorted list; and
for each strongly connected subgraph in the order of the sorted list:
identifying the vertices of the strongly connected subgraph as discovered; and
responsive to a strongly connected subgraph including a vertex identified as discovered, marking the strongly connected subgraph as incomplete.

4. The method of claim 3, wherein marking a strongly connected component as incomplete comprises:
for each strongly connected subgraph in the order of the sorted list:
responsive to a strongly connected subgraph not including any vertex identified as discovered, keeping the strongly connected subgraph as an SCC.

5. The method of claim 1, wherein marking a vertex as processed is performed using an atomic write operation.

6. The method of claim 1, wherein two or more threads process vertices of the same strongly connected components.

7. A non-transitory computer readable medium comprising stored instructions, which when executed by one or more computer processors, cause the one or more computer processors to:
receive a circuit design represented as a graph comprising a set of vertices and a set of edges;
for each vertex of the set of vertices, assign a state of the vertex as void;
perform by each thread from a plurality of threads executing concurrently to determine a set of candidate SCCs:
select a vertex from the set of vertices with state void;
perform a depth first search starting from the selected vertex; and
determine a candidate SCC based on vertices traversed by the depth first search; and
eliminate one or more candidate SCCs from the set of candidate SCCs and storing remaining candidate SCCs as SCCs of the graph.

8. The non-transitory computer readable medium of claim 7, wherein instructions to perform by each thread from a plurality of threads executing concurrently, cause the one or more computer processors to:
mark a vertex as processed once the depth first search initiated from that vertex has been completed, wherein the depth first search skips vertices that are marked as processed.

9. The non-transitory computer readable medium of claim 7, wherein instructions to eliminate one or more candidate SCCs, cause the one or more computer processors to:
marking a strongly connected subgraph that is a subset of another strongly connected subgraph as an incomplete SCC; and
removing the incomplete SCC from the one or more candidate SCCs.

10. The non-transitory computer readable medium of claim 9, wherein instructions to mark a strongly connected component as incomplete, cause the one or more computer processors to:
sort the candidate SCCs in order of decreasing size as a sorted list; and
for each strongly connected subgraph in the order of the sorted list:
identify the vertices of the strongly connected subgraph as discovered; and
responsive to a strongly connected subgraph including a vertex identified as discovered, mark the strongly connected subgraph as incomplete.

11. The non-transitory computer readable medium of claim 10, wherein instructions to mark a strongly connected component as incomplete causes the one or more computer processors to:
for each strongly connected subgraph in the order of the sorted list:
responsive to a strongly connected subgraph not including any vertex identified as discovered, keep the strongly connected subgraph as an SCC.

12. The non-transitory computer readable medium of claim 7, wherein marking a vertex as processed is performed using an atomic write operation.

13. The non-transitory computer readable medium of claim 7, wherein two or more threads process vertices of the same strongly connected components.

14. A system comprising:
one or more computer processors; and
a non-transitory computer readable medium comprising stored instructions, which when executed by the one or more computer processors, cause the one or more computer processors to:
receive a representation of a graph comprising a set of vertices and a set of edges;
for each vertex of the set of vertices, assign a state of the vertex as void;
perform by each thread from a plurality of threads executing concurrently to determine a set of candidate SCCs:
select a vertex from the set of vertices with state void;
perform a depth first search starting from the selected vertex; and
determine a candidate SCC based on vertices traversed by the depth first search; and
eliminate one or more candidate SCCs from the set of candidate SCCs and storing remaining candidate SCCs as SCCs of the graph.

15. The computer system of claim 14, wherein instructions to perform by each thread from a plurality of threads executing concurrently, cause the one or more computer processors to:
mark a vertex as processed once the depth first search initiated from that vertex has been completed, wherein the depth first search skips vertices that are marked as processed.

16. The computer system of claim 14, wherein instructions to eliminate one or more candidate SCCs, cause the one or more computer processors to:
marking a strongly connected subgraph that is a subset of another strongly connected subgraph as an incomplete SCC; and
removing the incomplete SCC from the one or more candidate SCCs.

17. The computer system of claim 16, wherein instructions to mark a strongly connected component as incomplete, cause the one or more computer processors to:
sort the candidate SCCs in order of decreasing size as a sorted list; and
for each strongly connected subgraph in the order of the sorted list:
identify the vertices of the strongly connected subgraph as discovered; and
responsive to a strongly connected subgraph including a vertex identified as discovered, mark the strongly connected subgraph as incomplete.

18. The computer system of claim 17, wherein instructions to mark a strongly connected component as incomplete causes the one or more computer processors to:
for each strongly connected subgraph in the order of the sorted list:
responsive to a strongly connected subgraph not including any vertex identified as discovered, keep the strongly connected subgraph as an SCC.

19. The computer system of claim 14, wherein marking a vertex as processed is performed using an atomic write operation.

20. The computer system of claim 14, wherein two or more threads process vertices of the same strongly connected components.
